(19) United States
(12) Patent Application Publication
(10) Pub. No.: US 2007/0150413 A1
(43) Pub. Date: Jun. 28, 2007

(54) Apparatus and Method for Creating and Using Electronic Currency on Global Computer Networks

(76) Inventor: Frederick Morgenstern, Clearwater, FL (US)

Correspondence Address: JOHN C. SMITH, ESQ., 2499 GLADES ROAD, SUITE 113, BOCA RATON, FL, 33431, US

(21) Appl. No.: 11/468,269

(22) Filed: Aug. 29, 2006

Related U.S. Application Data
(60) Provisional application No. 60/596,069, filed on Aug. 29, 2005.

(51) Int. Cl. G06Q 40/00

(52) U.S. Cl. 705/39

(57) ABSTRACT

An e-commerce database system that maintains a list of merchant and customer accounts, each account has an assigned amount of UNEEs (e-commerce currency units) and identification information about the merchants or customers. The electronic currency units are purchased by a customer for placement into their UNEE account. Payments in UNEE's are made for purchases by the customer and result in a transfer of electronic currency from the customer's UNEE account to the merchant's UNEE account. Payments received by the merchant can be retained as UNEEs, or they can be converted into a national currency or other asset of value selected by the merchant. The merchant can also purchase UNEEs for use by the merchant. UNEE transactions between a customer and a merchant result in a request to the central database system with instructions to transfer the desired number of UNEEs between accounts. The availability of the UNEEs is verified by the central database system, and if funds are available, the UNEEs are transferred.

### BACKGROUND OF THE INVENTION

1. Technical Field

The present invention relates to computer networks used for electronic commerce. In particular, it relates to the creation and management of electronic currency for use in computer network transactions where an exchange of value occurs.

2. Background Art

The recent development of the global communications network known as the Internet has expanded from its inception as an “information highway” to the development of a new and rapidly growing form of commercial trade known as electronic commerce (“e-commerce”). The development of e-commerce has provided the opportunity for consumers with computers to purchase a wider array of goods and services. This development has created a more comprehensive and competitive business environment. In particular, e-commerce has created a global economy in which consumers have access to goods and services worldwide. While this has provided substantial benefits to consumers and merchants, it has created new problems associated with payments and settlements of e-commerce transactions. These problems extend to security issues related to verification and authorization of existing payment methods and settlements of transactions within a diverse global currency environment.

The weaknesses of current technologies for secure payment, transfer and settlement of financial transactions on the Internet fall into at least seven (7) primary categories: 1) verification that the individual executing the transaction is authorized to do so; 2) verification that the method of payment is authorized for the amount of the contemplated transaction; 3) taking steps to determine that steps 1 and 2 are not a fraudulent transaction; 4) the prerogative of the consumer when using existing payment mediums (especially credit cards) to dispute or deny the transaction and reverse or cancel the transaction; 5) the hardware systems and the electronic encryption protocol, including software, required to have existing payment mediums interface with e-technology (Internet) payment mediums; 6) fluctuating and diverse currency values as compared to fixed product and service values in the e-commerce marketplace; and, 7) the degree of anonymity attainable to protect the privacy of those engaged in e-commerce while complying with applicable local, national and international laws.

In the conventional marketplace, prior to the development of e-commerce, a consumer would make payment for goods or services either in person at the point of purchase using conventional payment methods such as cash, credit card or check (negotiable instrument) or effect or authorize a transaction using one of a variety of credit or debit mediums from a remote location including C.O.D. (cash on delivery) arrangements. Alternatives to “in person” point of purchase were the ordering of goods and services via telephone and providing payment by credit card or by sending a check through the mail. This system of commerce and settlement is substantially the same for catalog sales and sales generated by television advertising including “infomercials.” In the conventional commercial model, the relationship between customer and merchant is established; the goods or services desired are considered and then selected; payment is made and the consumer and merchant complete the transaction. In the event that the consumer becomes dissatisfied after the sale, or the product is inoperative or does not meet the purpose intended, the consumer can readily return or exchange the merchandise at the transacting merchant. Rarely does a situation arise where the customer and merchant do not negotiate a solution to the disrupted transaction. The elements of conventional commerce are the consumer, the merchant, the product or service, and the payment medium chosen to consummate the sale.

While this type of commerce and the concurrent payment methods are suitable for conventional commercial activities, the high-speed and remote location of persons and merchants engaged in e-commerce poses challenges to current monetary systems. In the e-commerce environment, transactions occur globally in remote and diverse localities in virtually every monetary system that include person to person, person to merchant, and merchant to merchant transactions. The problem emerges in that while services and goods can be provided immediately, the slowness of conventional payment methods and the difficulties with secure payment verification impacts the ability to complete transactions and to deliver the goods/services as fast as possible. E-commerce, if it is to be successful long term, needs a system of monetary settlement that corresponds with the unique environment of the Internet. It is desirable that this system be compatible both inside and outside of the Internet environment and have features that enhance the speed of each transaction; that provide a degree of anonymity and security for those transacting business within the environment and that achieves a seamless monetary exchange and settlement process.

E-commerce, by its very nature, exists in a world where those engaged in it are unidentified by the standards applied in the conventional commercial marketplace. It would be desirable to facilitate payment in a more rapid manner to take full advantage of the ability of e-commerce to deliver goods/services at the speeds it is capable of. Also, where individuals, entities or institutions require a secure, high-speed medium of monetary payment or transfer, a type or system of universal value exchange is desirable. The need for such a system exists as a solution to the current limitations of e-commerce compounded by unidentified users, indistinct geographical locations and diverse economic systems.

There are many other elements that are significant to each e-commerce transaction. In the conventional marketplace, desired goods are generally purchased after physical examination and comparison with other “on hand” competitive products. In e-commerce, this does not occur. Also, once a purchasing decision is made using e-commerce, there are shipping costs and the related time delay in receiving the goods. There can be losses or damages in shipping requiring insurance solutions. Where any of the elements of dissatisfaction occur in an e-commerce transaction, including simply changing one's mind, a consumer may have little difficulty in reversing the sale. While this option seems to protect of the rights of the consumer on the one hand, it causes extreme challenges for merchants and those processing the payment for the transaction on the other. For example, the consumer may choose to call the credit card company and dispute the transaction. This is a major barrier to successful e-commerce as credit card companies allow their cardholders to initiate transaction disputes for nearly any reason. This action shifts the credit card issuer into the customer side of the transaction but not for the purpose of granting credit and monitoring the use of credit but rather as a barrier to a completed sale. This eventuality is not good for either the merchant or the customer. By removing the opportunity for the customer and merchant to negotiate a solution, the credit card issuer now becomes a mediator in achieving customer satisfaction. The ease of disputing a transaction increases the likelihood of a charge-back to the credit card bank causing the bank to increase the amount of reserves that the merchant must now maintain against future charge-backs and a vicious cycle ensues. Typically, during the dispute period, the credit card issuer credits back the amount of the dispute increasing its credit risk pending the outcome of the dispute. In many cases, the credit card issuer coerces the merchant to accept the dispute in the interest of customer satisfaction while ignoring the damage to the merchant.

It would be desirable for a medium of payment to exist that more readily simulates the conventional commercial environment. This would be where the medium of payment is more like cash where solutions remain between the merchant and the customer and where the rights and responsibilities of both parties are clearly known. Where the medium of payment becomes the intermediary for customer satisfaction, commerce breaks down.

Another major drawback to conventional payment systems is that they are tied to national currencies. In conventional economic activity, the merchant and the customer are typically located in proximity to one another, and typically use the same national currency. The global nature of the e-commerce economic market has created a situation in which frequently the merchant and the customer are in different countries which have different national currencies. This creates a currency exchange problem which can slowdown transactions and impede sales. It would be desirable to have an e-commerce system in which economic transactions could be completed independent of national currencies. In larger transactions, a fluctuation in currency value can eliminate profitability where negotiations of the sale and its terms may extend for a relatively long period of time. This is especially dramatic in softer currency environments involving exporting of e-commerce products that are arranged over the Internet.

As a result of the proliferation of computer technologies in nearly every geographical and socio-economic setting, all individuals, entities and institutions now engaged in local commerce have the opportunity to participate in global e-commerce and the concurrent advantages that are afforded. To open this opportunity in a realistic and productive way, new technologies must be employed that will permit it to be effective and efficient. Heretofore, the local commercial environment created a kind of economic isolation where economic transactions were typically limited to locally offered goods and services and typically used local currency. The local environment dictated prices, profit margins, quality and selection. The local commercial environment imposed itself on the consumer because of the limitations and inconvenience of obtaining goods elsewhere. The world of e-commerce is entirely different. There are no boundaries or apparent limitations other than how payment is accomplished and perhaps shipping costs.

When this same principle is applied to currency issues, in the conventional marketplace, the holder of any local currency must use that currency where it is accepted. In environments where local currency experience wide fluctuations, the holder of the local currency is victim to fluctuations and changes in economic and political circumstances. The holder buys what is needed and holds onto the remainder. This reserve can be seriously eroded. Heretofore, the only remedy to this has been to dispose of local currency into the marketplace often suffering even more extreme economic loss. Within an individual national currency system there may be no existing remedy to fluctuations in currency exchange rates. The advent of e-commerce and the Internet has changed this circumstance but only theoretically since no universal electronic currency exists. A universal electronic currency would enable every individual, entity or institution to benefit from fluctuations in the value of their local currency by converting to the universal electronic currency thereby enabling them to enter the global e-commerce environment with certainty of value and ease of exchange. This opportunity could expand exports in softer currency environments and improve national economic conditions by achieving a greater balance of trade in developing countries.

While the creation of the Internet and e-commerce has resulted in a new channel of trade that allows high-speed delivery of goods and services between merchants and customers located anywhere in the world, the prior art has failed to provide a payment system which allows payments to be made which are immediate and which eliminate the need for a merchant or a consumer to be concerned with national currencies or exchange rates. Likewise, it would be desirable to have a mechanism by which person-to-person monetary transfers are made that involve family members, business associates or other relationships in the same manner as that proposed between the merchant and the consumer.

### SUMMARY OF THE INVENTION

The present invention solves the foregoing problems by providing an e-commerce account in which electronic currency is used in lieu of conventional national currency payment systems. A central database system maintains a list of merchants and customers. All participants using the present invention are members or customers of the system, whether a merchant, a person, an institution, or an entity. Therefore, any description of the method or procedure within the invention that refers to any transaction can occur between any combination of members or customers. In this example, the merchant/customer list contains identifying information about the merchants and customers. In addition, it maintains account of available e-commerce currency units for each merchant and customer. The electronic currency units may be purchased by a consumer for placement into the customers e-commerce account or may be credited to the e-commerce account of a customer in other ways such as award programs, promotions, rebates, merchant returns, etc. Once purchased, the number of e-commerce currency units in the customer account remains the same regardless of fluctuations in national currency exchange rates. Payments made for purchases by the customer result in a transfer of electronic currency from the customer's e-commerce account to the merchant's e-commerce account.

Payments received by the merchant can be retained as e-commerce currency units for use by the merchant in the normal course of business, or the e-commerce currency units can be converted into a national currency at the direction of the merchant. The national currency selected by the merchant can be the currency used where the merchant is located, or any other national currency. The merchant also has the ability to purchase e-commerce currency units for the merchant's own account. Of course, the merchant only has the status of merchant based on the particular transaction the merchant is engaged in. Since the combinations and/or variables of the consumer/merchant mix are entirely interchangeable, the consumer can become a merchant in its next transaction, and the merchant can become a consumer in its next transaction. With Web page technology, where display of goods and services for sale is available to everyone, the ability to enter e-commerce is absolute and bound only by establishing an acceptable, interchangeable payment method.

In the present invention, e-commerce transactions between a customer and a merchant are made by a payment request from the customer to the central database system with instructions to transfer the desired number of e-commerce currency units to the account of the merchant. The availability of the e-commerce currency units is verified by the central database system, and if funds are available, e-commerce currency units are transferred. Refunds by the merchant to the customer are made in the identical, but reverse, manner.

### BRIEF DESCRIPTION OF THE DRAWINGS

FIG. 1 is a block diagram that illustrates the client/merchant connections to the e-commerce database server.

FIG. 2 is a flow chart which illustrates and e-commerce transaction in which a customer contracts with a merchant Web site and the UNEE exchange Web site.

FIG. 3 is an exchange table with sample currencies used by the currency exchange on the UNEE Web site.

### DESCRIPTION OF THE PREFERRED EMBODIMENT

Prior to a discussion of the figures, a general overview of the features and advantages of the invention will be presented. This invention provides a Universal Electronic Equivalent (hereinafter referred to as a “UNEE”) for conventional national currencies or precious metals which is used on computer network systems to increase the speed of e-commerce transactions and to make e-commerce transactions more convenient for both the customer and the merchant. The invention provides a standard of value determined by purchase or exchange from any national currency or precious metal into an electronic currency that is a universally acceptable unit of value called a “UNEE.” The UNEE system embodies a Web-enabled, online payment system that utilizes and offers a universal electronic equivalent currency (the “UNEE”) that can be converted to and from all national currencies and precious metals (and eventually, jewels, art and other recognized objects of value). Other existing online payment systems, and those that may in the future emerge, that can demonstrate sufficient security and privacy requirements consistent with the UNEE system and that are in compliance with applicable local, national and international laws, can access the UNEE system and exchange and interface with it to accomplish e-commerce. The UNEE system will interface with systems that maintain certified metal-denominated accounts that are backed by physical metal deposits in safe repositories. The holder of a UNEE is anonymous as each account is established and managed by use of a unique numbering system.

In the arena of electronic (digital) money, privacy has long been a concern and a goal of civil libertarians. This is largely because of the potential for electronic eavesdropping that computer databases, including checking account and credit card information, have given to both governments and businesses. The ability to track the spending patterns of individuals creates the foundation to know most of the details of a person's life, revealing more than most people would want known to others.

The solution to this problem is an electronic cash equivalent, the standard of which could be the UNEE, that can be spent or transferred without the vendor or other information-gathering-entity knowing the identity of the spender or transferee. One solution to this privacy problem is true digital anonymity, accomplished via several forms of public/private key encryption which allow consumers to buy digital money (the UNEE) bearing unique and non-reproducible identifying codes that can be matched against a databank for verification, reproduction in case of loss (i.e.: travelers checks, etc.), and the prevention of fraud (i.e.: double spending, etc.). This type of system has met with resistance from law enforcement agencies and other governmental entities because it implies an almost foolproof method of money-laundering for the intentionally unlawful and creates a system that may appear contrary to the “know your customer/client” conventions that are now internationally well known to prevent money-laundering or other unlawful money related transactions. True anonymity also empowers the unlawful who engage in fraudulent transactions without the fear of being traced.

In the UNEE system, there is and will be a demand for true anonymity but, for most people, pseudo-anonymity will provide sufficient privacy protection. In the UNEE system, records of who purchases digital money (the UNEE) are kept securely by a processing agency in a jurisdiction with a high regard for privacy so that customer information is only available to the proper authorities if those seeking such information or data meet the legal requirements of that jurisdiction. Even jurisdictions having strict bank secrecy rules will cooperate with authorities when presented with sufficient evidence of unlawful activity so long as the request complies with local applicable laws. One compelling advantage of pseudo-anonymity over true anonymity is that it is far easier to gain permission for such a system from most government authorities and to comply with national and international money laundering conventions. The UNEE system, including its software and encryption technologies, is formatted to operationally comply with such conventions while protecting the privacy of its account holders and members.

While the UNEE has a primary purpose as an electronic currency for use in commercial transactions, it can be used in non-commercial situations as well, in the same manner as conventional national currencies. It can be used in commercial, private and/or personal interactions where any combination of individuals or entities or institutions may choose this currency over other mediums of payment to complete any transaction requiring monetary consideration or settlement. The UNEE creates, and is not limited to, person to person, person to merchant, and merchant to merchant payment. It provides a universal, international, monetary exchange solution in the global commercial marketplace. It also provides an opportunity for individuals or entities to convert local currencies into a monetary standard that is acceptable throughout the global electronic marketplace.

The UNEE system is designed to include the “universal electronic equivalent” of other environments and topographies as well. The system is designed to launch a number of virtual marketplaces or online exchanges using current and emerging technologies. Within these environments, and those envisioned, the UNEE system will feature a wide array of member and customer services ranging from classified buying and selling systems, interactive communications (i.e.: e-mail, internet telecommunications, etc.), search engine services, new product design and release concepts, all types of consumer finance options and virtually unlimited services relating to the use and transfer of money.

The first of these environments is an online mall consisting of a catalogue system and links to all UNEE enabled and authorized merchants. The second is a shopping village (ie: “UNEEvillage”) utilizing a blend of an on-line mall, an online auction for both sellers and buyers, and a deep discounted product and services line featuring “UNEE selected products and services” that are supported by manufacturer or supplier promotions. The third is a Web based stock brokerage for members and customers that provides, through UNEE accounts, access to all world stock and bond markets in real time called “UNEEtrade”. The fourth is the worldwide network of cellular phones and network enabled cash registers, ATMs and other point of sale devices.

Because the UNEE system is a universal electronic equivalent, its use extends beyond e-commerce. This extension calls for the creation of a sub-system where the supply and demand for global goods and services, in addition to stocks, bonds or any other commodities, is monitored and measured not as existing commercial or trading models are, where brands and skilled advertising campaigns dominate but rather, by consumer design and request. The UNEE system recognizes that the future of brand loyalty on the Internet may not be to a strong traditional “bricks and mortar” retailer or brokerage or one of the promising Internet shopping brands or online brokerage services. Rather, all buying and selling, in addition to stocks, bonds and commodities will become far more “market-driven” where all pricing for products and services will be constantly fluctuating according to supply and demand. It is foreseen in this economic model that everything bought and sold will be treated as a commodity and traded on an “exchange.” This economic revolution would exploit the 24 hour a day/7 day a week global marketplace introduced by way of the Internet and lead to the operation of true fluid markets and real-time dynamic pricing.

The tool that has made this economic model possible is the advent of the “bot.” Bots are relatively simple computer programs that act as information couriers in a digital environment and can be highly “personalized.” The UNEE system utilizes “bot” technology in its virtual marketplaces and exchanges. Over time, these personalized shopping engines called “shop-bots”, will overtake retail brand loyalty by navigating the virtual marketplace and finding exact matches based on individual consumer specifications and requests. The discussion that follows is oriented to the commercial marketplace for goods and service but is applicable to all commerce or exchange environments.

An objective of the UNEE online shopping concept is to be viewed as a “least” price Web site by the Internet's shopping and rating magazines, sites and intelligent agents (bots). To accomplish this, a shop-bot that is programmed to instantly find the best prices on everything from books to music to software and sporting goods is launched. The bot search provides an easy way to comparison shop for products in many different categories. A click on the search result sends the user straight to the product order Web page. These bots would weigh an individual buyer's preferences for reliable on-time delivery along with vendor history or rating as well as price. No matter how well a consumer is treated in a conventional commercial environment, a personalized shop-bot that knows the individual's likes and dislikes will be far superior due to its efficiency and results. Web site preferences will survive only so far as they become television networks or entertainment portals.

As consumer product specification data is assembled as a categorical database, it becomes useful for the supply side (manufacturers of products and suppliers of services) as well. Products can be designed interactively in a “made to order” fashion based on hundreds, thousands or even millions of sorted specifications that more precisely fits consumer demand. Rather than developing a hard model or a product and “test marketing” to measure demand, the UNEE system includes a virtual, interactive “industrial design showcase” where designers of new products or services can present a theoretical product in UNEE's “virtual design showroom” and allow consumer input before further design and production. This type of new product and service design approach encourages consumer input and participation. The theoretical product would be displayed and consumer input would come into the displayer's secure Web page and the precision design process would follow. The displayer would already have its buyers lead list based on the consumer input when the new product is ready for release. This model would assist manufacturers in financing since the consumer demand is certified by way of the showroom database.

An extended service of the UNEE system is designed to conquer the difficulties encountered by Internet shoppers who log on the Internet, go to a shopping mall site, fill out a search form, follow the links to a half a dozen Web merchant sites and then must navigate the lowest price merchant's shopping cart system to finally negotiate a purchase. The profile of users using the UNEE site does not differ significantly from standard Internet shoppers.

These users will be facing the identical challenges that all Internet users do with the added necessity to work with the programming of their personal shop-bot. Though users are attracted by lower prices, the completion of the transaction in the current technology by using a credit card, for example, is replaced with the invitation to establish an account denominated as UNEEs and program a shop-bot. In the process of examining that invitation, customers will be informed of the new capabilities that come with UNEEs, such as the power to effortlessly transfer funds from individual to individual via the Web.

In addition to other customer service options, the less Internet knowledgeable UNEE clients will be able to call an 800 (toll free) number and speak to a trained representative who will personalize a shop-bot or conduct an Internet search to locate the item or service desired. A voice activated interface for the UNEE system can also be used in place of older input technologies.

This service can be provided on an Internet wide basis whether a merchant is UNEE enabled or not. Over time, the UNEE merchants with the cost advantages experienced in the UNEE system, will lead the winning quotes in product review, shopping sites and bots. These trained representatives can also serve to explain the UNEE as a financial product in conjunction with an online discount, multiple currency trading account or other equities or debt instruments trading accounts offered within the UNEE system.

For ease of discussion, the terms “customer” and “merchant” will be used to indicate the relationship between two entities in which one entity (a customer) is providing the value equivalent (i.e. the UNEE), and the other entity (a merchant) is receiving the value equivalent either as a gift or in return for goods or services. However, those skilled in the art will recognize that these terms only apply to a particular entity in relation to a single transaction. For example, an entity that acts as a merchant in one transaction by providing goods or services to a customer, may, in another transaction, act as a customer by purchasing goods or services.

The invention provides a unique method for processing an Internet currency which is independent of national currencies and enables a consumer anywhere in the world to purchase goods/services from a merchant anywhere in the world without having to be concerned with currency exchange rates, collection problems, etc. The UNEE functions as a cash equivalent with its primary application (arena) being the Internet. Those skilled in the art will recognize that while any computer network is capable of implementing this invention, the Internet, as the primary virtual commercial environment, provides the theoretical ability for all customers to have worldwide access to all merchants. The UNEE solves the problems posed by prior art methods of payment (check and credit card purchases etc.) by providing a medium of exchange between buyers and sellers of good and services that is a cash equivalent. The UNEE allows monetary transactions to occur via the Internet, and/or, by cellular telephone, land line telephone or any other digital transmission network, by way of any device enabled to transmit or receive downloadable code without the overhead costs and time delays associated with the verification, authorization and processing issues inherent with checks, credit cards, debit cards and other existing methods of payment or monetary transfer.

As the invention develops, any means where a transmitter signal and a receiver signal can be established and exchange downloadable code, such as computer modems, infrared devices, telephone lines, cellular phones, handheld computers, cable systems as in televisions, satellites etc., the UNEE system can be operated. This includes opening an account, transferring funds, purchasing and/or selling goods and services and all other e-commerce transactions or combinations of e-commerce and conventional e-commerce transactions that occur between person to person, person to merchant, and merchant to merchant. The spectrum of these methods includes the ability to purchase UNEEs in the form of prepaid cards at conventional commercial outlets such as convenience stores, grocery stores, gasoline stations, etc. to an Internet enabled cellular phone digital purse or wallet. This system operates by way of cellular phone delivery of UNEEs at the point-of-sale by using a specially engineered cellular phone that is World Wide Web (Internet) enabled. This device has an interface integrated into it that can instantly receive and/or send UNEEs through the cellular network system or, by way of its signal, dial into any other receiving system at point-of-sale, such as cash registers. The UNEE system can be accessed by way of this signaling device interface with any system that is capable of reading and sending downloadable code.

This ability to utilize any Internet enabled cellular phone or device as a portable terminal for all commercial transactions extends to all handheld computers or personal digital assistants. This system can replace all the financial payment instruments normally carried in a wallet or purse. These include credit cards, debit cards and ATM cards as well as the conventional checkbook. Any transaction, including verification and processing of account debits and credits within the UNEE system can be accomplished by using any Web enabled device.

Where point-of-sale devices are encountered that are not yet Internet enabled, a special 802.11 antenna, or equivalent device, can be retrofitted to allow access to UNEE's digital network. Any Internet enabled site or phone, handheld computer or personal digital assistant becomes a personal, private, portable cash machine or terminal that can access UNEE's digital network for utilization of virtually any type or combination of monetary transaction.

The UNEE systems Web wallet design creates a lawful client and customer anonymity environment where the cellular phone delivery of UNEE's at the point-of-sale and cellular phone to cellular phone transfers of currency based assets occur. The UNEE system can integrate with land line or cellular telephone numbers whereby such numbers would become UNEE accounts. This would enable phone number to phone number transferring of currency based assets in much the same fashion as conventional bank accounts do today. The difference would be that a transaction so enabled would offer full real time access and the lawful anonymity that a transaction conducted within the traditional banking system does not.

In addition to the speed and convenience of the UNEE as a cash equivalent, the UNEE eliminates problems related to exchange rates which are associated with the use of national currencies. In the global economic market which e-commerce has created, national currencies create delays, expenses, and additional overhead costs, and in some instances, they restrict or eliminate entries into the e-commerce opportunity. The UNEE provides a single currency equivalent which can be used as cash worldwide.

Initially, in order to provide stability in value when circulating the UNEE, the UNEE is envisioned as being fixed in value in a 1:1 ratio to the U.S. dollar. Eventually, it is envisioned that the UNEE will become a tradable non-governmental currency in the world currency market, and may float in value against other currencies, including the U.S. dollar. This may alter its value from time to time as all currencies experience fluctuations but, as with all world currencies, the standard of measurement of current market value is against the current value of the U.S. dollar. An additional advantage of the invention is that by setting the value of the UNEE to be equivalent to the U.S. dollar, transactions can be made between parties in countries that may have soft currencies which will allow the parties to have confidence in the value of the bargain struck between the parties. In such negotiations, the UNEE is a standard unit of “one” thereby facilitating and contributing to deal making without the use of fractional or extreme multiples of units that can become very confusing when negotiating in diverse currencies. This eliminates one concern of the parties that will ultimately lead to an increase in total economic activity.

Further, as a universal exchangeable currency on the Internet and potentially other electronic funds transfer environments, the UNEE provides a store of value. This is particularly applicable to the populations of developing countries without access to hard currency or credit card payment mediums. In these countries, inflation rates of the local currency are often high, and depreciation occurs rapidly. Because the UNEE is a global currency, pegged to the dollar and in real time, weighted against all other national currencies, the purchase of UNEE's in such economies would create a stable, electronic, universally accepted standard currency for a myriad of commercial or personal purposes.

In the preferred embodiment, the UNEE is implemented as follows for the customer: In addition to conventional credit card payment methods such as Visa, Mastercard, American Express, Discover, etc., when the consumer visits a Web site that accepts UNEEs, the customer will be offered an option to pay in UNEEs. If the customer has a UNEE account, the customer account number and password or personal identification number (PIN) is entered and upon purchase, the customer's UNEE account is debited. If the customer does not have an account, a Web page hyperlink is presented that takes the customer to the UNEE Web site where an account can be opened. The customer can submit funds to open the account and purchase UNEE and one of several ways. These include, and are not limited to, conventional payment methods, such as checks or other negotiable instruments, (which is a slow process). Funds can be used to acquire UNEEs immediately by way of a credit card in the form of a cash advance, debit card, electronic check debit, cellular phone, telephone, or any other electronic or digital data transfer system that otherwise transfers funds through any electronic network or access system. For example, the UNEE can be purchased by direct billing to a telephone account. This method of billing would allow anyone to bill the purchase of UNEEs to their telephone bill and have these UNEEs immediately credited to their account.

The UNEE is intended to take advantage of emerging smart card, including prepaid swipe card, technologies. The customer can purchase UNEEs in the form of a smart or swipe card from a local outlet. The smart or swipe card will allow the UNEE to be used outside of the Internet in devices such ATMs, gasoline pumps, etc. In the case of smart or swipe cards, the cards can be denominated as UNEE's, or alternatively, they can be paid for in UNEEs and denominated in local currency at the time of purchase. Preferably, the currency is activated when the consumer opens an account at the UNEE Web site and inputs the applicable codes that are inherent in the type of card used or purchased.

Regarding the merchant, in the preferred embodiment the UNEE is implemented as follows: first, the merchant registers with the UNEE system. In order for the merchant site to accept UNEEs, it must have a software payment system that is compatible the UNEE system. The UNEE system furnishes the merchant with software and encryption technologies to properly interface with the UNEE system. The UNEE provides a benefit to the merchant because, unlike other payment systems such as credit cards, the UNEE is treated like cash rather than a conditional sales contract. Purchases made with the UNEE are treated in the same manner as a cash sale. Each UNEE merchant must have a published return policy that complies with both applicable local laws and the UNEE merchant agreement. As a result, the UNEE is an electronic cash equivalent currency. Fees for using the UNEE can be based on a variety of factors, such as the number of services utilized by the merchant, gross sales and other conventional and non-conventional measurements and incentive programs.

In the preferred embodiment, the UNEE database system controls acquisition, redemption, and exchange of the UNEE in the following manner. The UNEE currency is traded at a central Internet Web site (for example, www.unee.com). This site is used as an online exchange site where the UNEE can be bought or sold. The UNEE is pegged to the U.S. dollar. Exchange rates with all major currencies will be posted on the site and these currencies can be converted into the UNEE. Exchanges are done on par, using the daily conversion rates for the US dollar.

When a merchant or a customer purchases UNEEs by way of any technology that exists or is developed encompassing or utilizing an instrument, card, digital transfer system, checks, credit cards, cash advances, debit cards, electronic debits, cellular phones, etc., funds can be transferred into the merchant's or customer's UNEE account. If the funds being transferred in are not in U.S. dollars, then the funds would be measured as U.S. dollars using the current exchange rates and deposited as UNEE's. At that point, the national currency would have been converted into a UNEE currency equivalent.

The same process is performed in reverse when the merchant or customer wants to convert the UNEEs in the UNEE account to a national currency. In this case, if the currency desired is U.S. dollars then a 1:1 conversion is performed (or the current market rate of the UNEE in relation to the U.S. dollar). In the case where a non-U.S. currency is desired, the current exchange rate table would be consulted and the appropriate conversion would be performed.

The UNEE database server is also capable of functioning as a virtual bank. In particular, in addition to the exchange option, the site allows the customer to create a UNEE account, to view the customer's UNEE balance, and to make transactions. An added feature of the customer account screen is a “purchase data screen” where the customer can alter and limit the data that the corresponding merchant, individual or entity receives in a transaction using UNEEs or the UNEE transfer system. The customer has the opportunity to restrict personal data and transact in a virtual “cash like” manner rather than deal with existing payment methods that can be both intrusive and compromise privacy. An authorized account holder can add to a UNEE account balance from any digital transmission device in one of four ways: 1) by entering the serial number of a previously purchased, or assigned UNEE note; 2) by purchasing additional UNEEs with a credit card; 3) by earning UNEEs in exchange for demographic information, purchasing preferences, rejection of advertising coupons, awards, rewards, winnings, points or proceeds of other incentive type programs, etc.; or 4) by an advance or transfer from a third party including an advance from the UNEE if a credit line is granted by UNEE or from a third party.

Before the UNEE is added to a specific consumer's account, it can be conceptualized as a note. The UNEE is assigned a unique number consisting of a combination of letters and numbers. This number is coded to contain the amount in UNEEs or can include an “open” amount where the UNEE customer has established a line of credit either from UNEE or a qualified third party. These UNEE notes are distributed when they are entered into a consumer account, and subsequently canceled when redeemed.

The ability of the UNEE based system to function as rapidly as it does is that it uses a third party to a transaction, namely the UNEE system, which acts in many respects as an escrow agent. For example, since the UNEE system receives payment from the payor in advance of an economic transaction, the funds are available from the UNEE system for the payee immediately. The payee is able to act immediately in response to a request for goods and/or services because it does not have to rely on the ability or intent of the payor to pay. The payee will also have a preexisting relationship with the UNEE system which allows the payee to act immediately to consummate the transaction because of its confidence in the UNEE system's ability to provide payment or settlement.

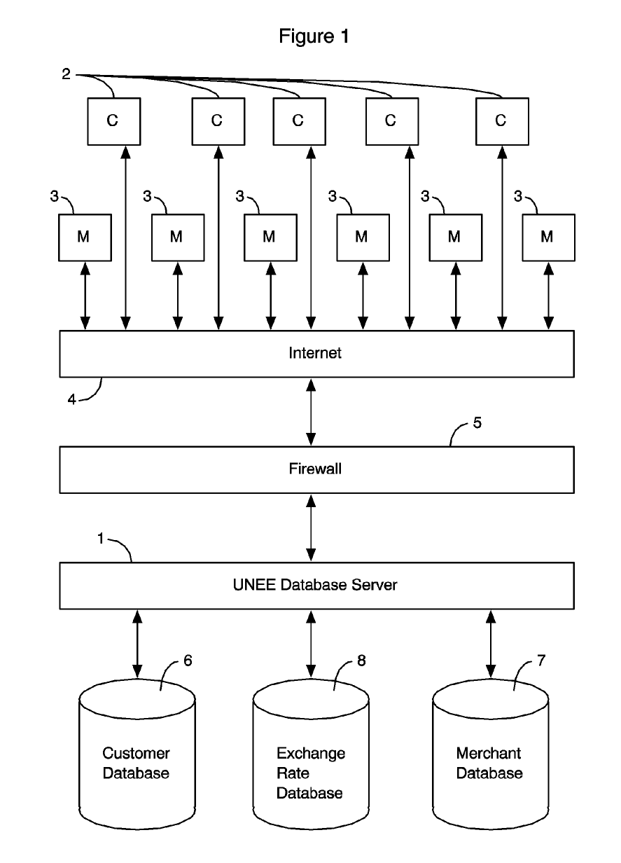

Referring now to FIG. 1, this figure is a block diagram that shows the UNEE database server 1. The UNEE database server 1 maintains a customer database 6, a merchant database 7, and an exchange rate database 8. The firewall 5 is used to provide secure access to the Internet 4. Access to the Internet, and use of firewalls for Web site security, are well-known in the art.

Maintaining high levels of security is important in this type of monetary environment to avoid intrusions and security breaches which are frequently experienced by credit card processors and credit card holders. To protect data sent over the Internet between the merchant's and customer's computers, the data is encrypted.

In the preferred embodiment, the UNEE system presents penetration by using a 2048 Bit Encryption, and in addition, the coding system of letters and numbers (which are very similar to currency serial numbers) that exhaust or expire upon use. In addition, a secret data file (key/certificate) is used to identify/authenticate each merchant, customer and transaction. This combination effectively prevents counterfeiting and system intrusion. Those skilled in the art will recognize that, as new technology emerges, encryption standards will be continuously reviewed and upgraded to insure the highest security and privacy for UNEE customers.

When a customer 2 desires to obtain or redeem UNEEs, the customer would directly access the UNEE database server 1 via the Internet 4 and the firewall 5. The UNEEs would be purchased, as discussed above, via credit card purchase or any other suitable means. In the case of redemption, the UNEEs could be redeemed in the form of a credit to a credit card, in the form of a check, in the form of an electronic funds transfer (EFT) deposit to a bank account, etc.

When the customer contacts the UNEE database server 1 to purchase UNEE's, the UNEE database server 1 will first determine if the customer has an existing account. If no account exists, the customer will be prompted for identification and password information, and then will be prompted to ascertain how much funds and how the funds will be provided to obtain the initial supply of UNEE's. If the customer is using an electronic method depositing funds, such as electronic funds transfer (EFT) or credit card purchase, the funds can be converted to UNEE's immediately. In addition, if the customer does not wish to electronically transfer funds to the UNEE database server 1, then conventional methods of funds transfer, such as checks, can be used to establish the account with the UNEE database server 1.

Likewise, the merchant 3 can also obtain and redeem UNEEs in a similar manner. The merchant 3 may wish to obtain UNEEs for the purpose of applying a refund to a customer or to use the UNEEs in the normal course of business. Of course, a merchant 3 can also act as a customer when dealing with other merchants 3. The merchant may also wish to convert the UNEEs back to national currencies to pay salaries, business expenses, taxes, etc.

When a customer 2 makes a purchase from a merchant 3, the customer 2 would first directly contact the merchant 3 Web site to select goods and/or services. Once a purchase decision was made, the customer 2 would link from the merchant 3 Web site to the UNEE database server 1 to authorize payment of UNEEs to the merchant 3. The UNEE database server 1 would then debit the account of the customer 2 and credit the account of the merchant 3. The merchant 3 would then be notified that its account was credited. The merchant 3 can then ship the goods and/or provide the services immediately because the transaction was equivalent to a cash transaction. As a result of the similarity between a UNEE payment and a cash payment, the speed of transactions can be greatly accelerated because the payee does not have to wait extended periods of time to ensure that funds have actually been transferred before providing the goods and/or services.

For ease of discussion, the customer database 6 and the merchant database 7 are shown as separate databases. However, though skilled in the art will recognize that both of these databases may be implemented as a single database. Likewise, since the status of customer and merchant will vary based on individual transactions, the individual customers and merchants do not have to be so classified in the database and they may in fact be stored as identical database entries.

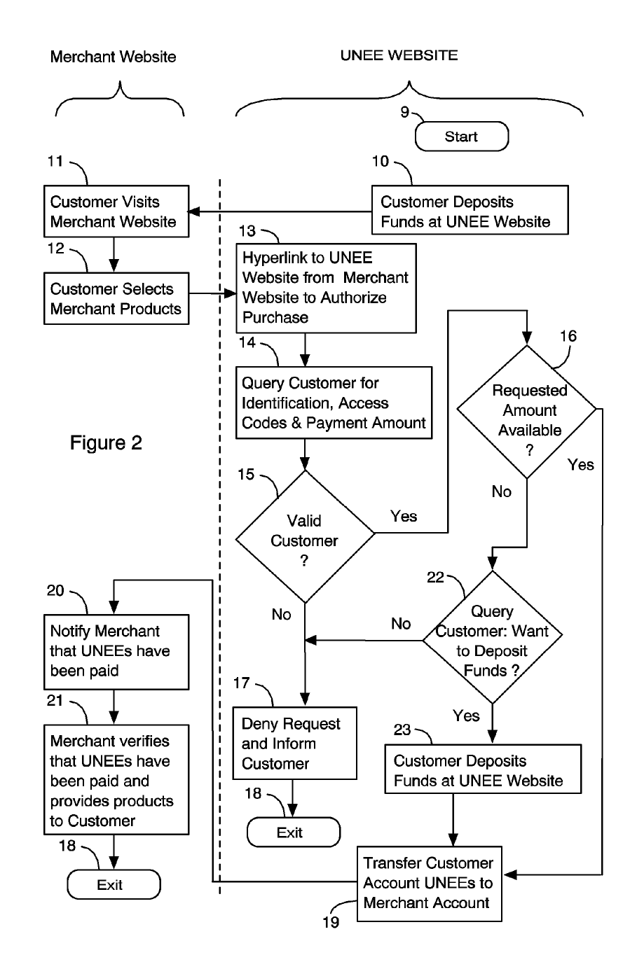

FIG. 2 is a block diagram that describes the sequence of events to take place to accomplish the transfer of goods and services using a universal currency equivalent without the use of a national currency. In this figure, the customer starts at starting point 9. The customer links to the UNEE Web site at step 10. If the customer does not have a valid UNEE account, which would be the case the first time to customer visited the UNEE Web site, the customer would be queried to determine if the customer wanted to open account. When a customer desires to open account, the system would query the customer to determine identity information, including name and address information, age information, etc. Further, depending on the political jurisdiction the customer lives in, appropriate tax information (for example, U.S. Social Security identification information) and/or other information would be obtained. The membership data collected and the due diligence performed about the user of the UNEE system will be sufficient or exceed local, national and international conventions that comply with the “know your client/customer” rules. This information, however, is strictly protected to ensure the privacy of the UNEE system member or customer. Once this information was gathered, a customer could be established as a valid user of the system.

After the account is established, the system must provide for secure access to the account. Since UNEE's are currency equivalents, access to the individual customer's account is protected by a security and encryption system to ensure that only an individual with a valid user ID a valid password or PIN (i.e. the customer) and authentic key/certificate can access that particular account. The password selection is part of the initial account setup and limits access to the account to the customer and further ensures the privacy of the customer.

At this point, the system would inquire as to whether or not the customer desires to deposit funds in the account for conversion to UNEEs. When the customer indicates that the deposit was to be made, the system would interrogate the customer to determine the amount of the deposit in the source of the funds. If the funds came from electronic funds transfer for via credit card deposit, and that amount of funds would be available immediately for conversion to UNEEs. On the other hand, if the customer indicated that funds would be deposited by check or other relatively slow method of deposit that requires clearing or collection time, then the funds would not be available until those funds were actually collected by the UNEE system. When the funds were available, they would be converted to UNEEs at the current exchange rate.

As discussed above, one method of establishing currency rates is to tie the value of the UNEE to a dominant hard currency, such as the U.S. dollar. This method is useful for customers living in countries which do not have hard currencies. Individuals in these countries would have the ability to convert their currency to a currency which was tied to a hard currency. The advantage of this method is that it allows those individuals to purchase goods and services worldwide without the difficulties associated with the use of soft currencies.

Tying the UNEE to a currency such as the U.S. dollar allows the UNEE to be converted to any currency using already available commercial exchange rates for currencies. Of course, to implement this type of exchange, the system must have access to currently available exchange rates for a trading day. This information would normally be provided by a commercially available third party database system.

Alternatively, an internal database can be maintained within the UNEE system that in itself would function as a currency trading floor. In this embodiment, the UNEE would not necessarily be tied to any national currency. A customer in France could convert French francs into UNEEs and use them for any number of transactions. When desired, the remaining balance would then be re-converted into any other currency, such as the U.S. dollar.

The advantage of either embodiment is that, for the first time, an individual would have what amounts of a global currency equivalent that is independent of national currencies, and when used with the global market provided by the Internet, allows the individual to have access to the goods and services provided anywhere in the world with a universal currency. The advantage to the merchant is that the merchant has access to customers on a global business and has immediate payments for goods and services which allows the merchant to safely provide the goods and services immediately and without fear of collections problems.

Once a customer account is set up at step 10, the user would then proceed to visit merchant sites at step 11. This could happen immediately after the account is set up, or at any convenient time in the future. While visiting the merchant Web site, the customer may select goods and/or services offered by the merchant at step 12. At this point the customer has several options. The customer can order via conventional methods, such as online credit card purchases, telephone ordering, or ordering via the mail. In addition, the invention provides an additional method of ordering goods and services: the customer can also make a cash equivalent purchase using UNEEs. If this method of payment is selected, at step 13 the customer will hyperlink from the merchant Web site to the UNEE Web site.

Once the customer arrives at the UNEE Web site, the customer will be prompted at step 14 for customer ID and password information. In addition, the UNEE system may also query the customer at this time for the amount and nature (i.e., purchase from merchant, withdrawal of funds, deposit of funds, etc.) of the transaction. The UNEE system will then use the customer ID information to access the customer's data file in the customer database 6. If the customer ID information is invalid, then the UNEE system will determine, at step 15, that the individual attempting to access the system has not entered a valid customer ID or does not have an authentic key/certificate. The UNEE system will then notify that individual at step 17, terminate the transaction, and exit at step 18. If valid customer ID information was entered, then the UNEE system will attempt to verify that the individual attempting to access the customer account has authority to do so. To accomplish this, the password information input by the individual will be compared to the customer's password information that is stored in the customer database 6 and the key/certificate residing in the customer computer will be checked for authenticity. If the customer is accessing the UNEE system from a remote location, a “remote” code access alternative is provided with the delivery of customer's password combination when the customer is initially accepted as a customer of the system. If the passwords do not match, then the UNEE system will determine that the individual attempting to access the customer's file has not entered a valid password. The UNEE system will then notify that individual at step 17, terminate the transaction, and exit at step 18.

If the UNEE system determines at step 15 that a valid user is executing a transaction, then at step 16 the system will determine if the amount of funds requested by the customer are available in the customer's account by comparing the account balance from the customer database 6 with the amount requested for transfer. If the funds are not available, then at step 22 the UNEE system will notify the customer and enquire as to whether the customer wishes to deposit more funds. If not, then the system will exit at step 17. If yes, then the system will proceed to step 23 to acquire the funds. If the funds are provided, then the system will ultimately transfer the UNEE's from the customer account to the merchant account at step 19.

In the preferred embodiment, the merchant identification information and total amount of funds requested for transfer are automatically transferred to the UNEE system when the customer hyperlinks to the UNEE system at step 13. By having the merchant system automatically append its identifying information as part of the hyperlink from the merchant system to the UNEE system, no input is required by the customer and the possibility of errors are reduced. However, those skilled in the art will recognize that a manual data entry process can also be used.

At step 19, the UNEE system will know the identity of the customer, know the amount that is desired to be the transferred, know if the funds are available, and know the merchant that will receive the funds. The UNEE system will then transfer the funds from the customer account to the merchant account.

The UNEE system will then contact the merchant system at step 20 and confirm that the payment has been made and that the funds were transferred from the customer account to the merchant account. At step 21, the merchant confirms the transfer of funds and authorizes the immediate shipment of goods or provision of services. This concludes the transaction which exits at step 18.

The UNEE transaction is significantly different from other types of transactions on the Internet, or other computer networks, or other commercial and private environments. First, it frees the customer from the burdens imposed by the nature of the customer's local currency. The UNEE is a worldwide currency equivalent which is convertible to and from hard currencies. As a result, when a customer using a soft currency converts that currency into UNEEs, the customer has the ability to make transactions anywhere because the UNEE has the qualities of a hard currency. Second, as can be seen from the foregoing figure description, the transfer of UNEEs from a customer account to a merchant account is equivalent to a cash transaction because it is immediate. In addition, it cannot be undone by the customer, such as the customer might be able to do by stopping payment on a check. Further, the UNEE system does not act as an arbiter in the case of disputes in the manner of a credit card company. A principal disadvantage for merchants, when using credit cards for customer transactions, is that the customer can dispute the sale with the credit card company. When this happens, the credit card company typically acts as an arbiter. As a result, the merchant may, or may not, be paid. Therefore, a principal benefit provided by the UNEE to the merchant is that the UNEE transaction is equivalent to a cash transaction. In any event, the merchant would be subject to its published customer return policies that comply with applicable laws in its jurisdiction along with those dictated by the UNEE merchant agreement, but the merchant remains responsible for dealing directly with the customer. The UNEE system becomes “an arbiter of last resort” meaning it will intervene only in those instances where non-compliance with the published return policies of the merchant occur and/or a breach of the terms regarding returns within the UNEE merchant agreement and/or in cases where non-compliance with applicable consumer protection laws have been violated. Another significant benefit to the merchant is that because a UNEE transaction is equivalent to a cash transaction, it is not subject to the high transaction fees imposed by credit card companies.

The UNEE also provides benefits to customers which are not available from other systems. First, because the UNEE is equivalent to cash, the customer is able to obtain goods and services faster than would be possible with slower payment methods such as checks. Second, the transaction fees are expected to be less than existing credit card merchant processing fees and this savings can be passed along to the customer in the form of lower prices. Third, a customer can travel anywhere in the world, or make a purchase via the Internet anywhere in the world, without having to be concerned about what currency might be needed in a particular location. Fourth, has a result of the customer code system that executes a purchase using UNEE system, the customer saves time by not having to input personal data each time a transaction is executed. The customer controls the information chosen to supply the merchant just the same as if the transaction were executed with cash. The customer remains in control of what private information is exchanged in order to complete the sale and permit the delivery of goods or services to any destination or site.

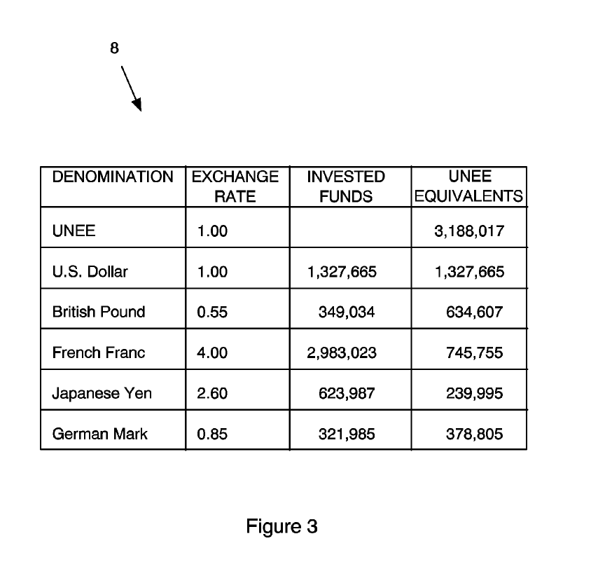

In FIG. 3, an example of an exchange-rate table contained in the exchange-rate database 8 is shown in which a variety of currencies have exchange rates that are related to the UNEE. For example, at a given point in time the U.S. dollar may have a 1:1 ratio with the UNEE, while the British pound may have a 1:0.55 ratio with the UNEE. As shown in the column titled “invested funds” a specific amount of actual currencies are deposited with the UNEE system. They are converted into UNEE equivalents based on the value in the exchange rate column. The total amount of UNEE equivalents shown in the figure is then available for use by customers and merchants.

The ability of the exchange-rate database 8 to maintain a real-time exchange rate table allows the UNEE database server 1 to function as a virtual currency trading floor. In this currency trading floor environment, the buying in selling of UNEEs is in any currency or combination of currencies is possible. In addition, by maintaining currency accounts in all of the national currencies deposited with the UNEE database server 1, the UNEE database server 1 can act as a market maker and take advantage of spreads in individual national currency purchases and sales.

For ease of illustration, the foregoing discussions have focused on the use of UNEEs as a substitute for national currencies. However, a national currency is an asset value. The system disclosed herein is capable of using other assets of value in place of, or in addition to, national currencies. For example, a customer may elect to deposit a non-currency asset of value, such as a specific quantity of precious metals, a government security (e.g. treasury bond, treasury note, etc.), a private note (e.g. a corporate bond, a corporate note, corporate stock, etc.), or a non-currency based property (e.g. fine art, collectibles, antiques, etc.). Of course, non-currency properties cannot be deposited electronically, which will result in a delay before they can be converted into UNEEs available in a customer's account. Likewise, valuations must be set for each type of property. The more unusual and unique the property, the more difficult it may be to set a valuation.

As can be seen from the foregoing, the UNEE provides people all over the world with the equivalent of a hard currency. In addition, because it is interchangeable with national currencies, precious metals, government securities, private notes, and non-currency based property it allows individuals to convert these assets of value into a single universal medium of exchange (the UNEE). In turn, the UNEE allows individuals to engage in economic transactions on the Internet on a cash basis.

The UNEE provides several other benefits. For example, the UNEE provides additional stability since once an asset of value is converted into UNEE's, the UNEE balance does not change if currency valuations subsequently change. The UNEE is illustrated above as a transaction between a merchant and a customer, but it can just as easily be a cash transfer between two individuals (i.e. customers).

While payments into the system for conversion into UNEE's has been discussed as a direct payment by the customer, payments can also be made by third parties. For example, a payment can be made via a third party as a result of an award program, a product promotion, a rebate, or a merchant refund.

While the invention has been described with respect to a preferred embodiment thereof, it will be understood by those skilled in the art that various changes in detail may be made therein without departing from the spirit, scope, and teaching of the invention. For example, any suitable operating system, server type, or database technology can be used to implement the invention. Any suitable network can be used in addition to the Internet, etc. Accordingly, the invention herein disclosed is to be limited only as specified in the following claims.

What is claimed is:

1. A method, including the steps of:
using a database to store customer account information and merchant account information;
accepting payment from a customer in an asset of value;
converting the payment into a predetermined number of non-currency exchange units and storing the non-currency exchange units in an account assigned to the customer;
receiving, via a computer network, a request from a customer for transfer of a customer specified number of non-currency exchange units from the customer to an account assigned to a merchant;
verifying the validity of the customer request and the availability of non-currency exchange units in the customer's account; and
transferring the non-currency exchange units from the customer's account to the merchant's account if the customer request is valid and the non-currency exchange units are available.

2. A method, as in claim 1, including the additional steps of:
assigning a unique and non-reproducible identifying code to each non-currency exchange unit;
maintaining a non-currency exchange unit database having information related to the ownership, creation date, and termination date of each non-currency exchange unit; and
creating new non-currency exchange units when a transfer from the customer to the merchant occurs, assigning the new non-currency exchange units to the merchant, and terminating an equivalent number of non currency exchange units in the customer account, the new non-currency exchange units further containing no information related to the customer;
whereby the non-currency exchange units received by the merchant do not contain any information related to the customer.

3. A method, as in claim 2, including the additional step of encrypting the non-currency exchange units.

4. A method, as in claim 1, including the additional step of:
notifying, via a computer network, the merchant that non-currency exchange units have been transferred from the customer's account to the merchants account.

5. A method, as in claim 1, including the additional step of:
notifying the customer when the customer request is invalid or when the number of non-currency exchange units requested are not available.

6. A method, as in claim 1, including the additional steps of:
storing an exchange rate database in a computer, the exchange rate database containing the exchange rate values of a plurality of assets of value in relation to the non-currency exchange unit; and
accepting payments for conversion to non-currency exchange units from any of the plurality of assets of value in the exchange rate database.

7. A method, as in claim 6, including the additional steps of:
reconverting, at the request of the customer or the merchant, a specified portion of the non-currency exchange units in the customer's or merchant's accounts, respectively, into one or more assets of value; and
storing a credit in a national currency or precious metals for the requesting customer or merchant for the amount of the assets of value reconverted from the non-currency exchange units.

8. A method, as in claim 7, including the additional steps of:
converting the credit in assets of value in the customer's or merchant's account into different assets of value at the request of the customer or merchant; and
using a computer to determine the appropriate exchange-rate for converting to the assets of value into different assets of value.

9. A method, as in claim 1, including the additional steps of:
reconverting, at the request of the customer, a specified portion of the non-currency exchange units in the customer's account into one or more assets of value; and
paying the national currency or precious metals to the customer.

10. A method, as in claim 9, wherein:
the assets of value converted into the non-currency exchange units by the customer is different from the assets of value reconverted from the non-currency exchange units.

11. A method, as in claim 1, wherein the asset of value is a national currency.

12. A method, as in claim 1, wherein the asset of value is a precious metal.

13. A method, as in claim 1, wherein the asset of value is a government security.

14. A method, as in claim 1, wherein the asset of value is a private note.

15. A method, as in claim 1, wherein the asset of value is non-currency based property.

16. A method, as in claim 1, wherein the number of non-currency exchange units is set at the time of the conversion from the asset of value and will not be affected by subsequent changes in the value of the asset of value.

17. A method, as in claim 1, wherein the customer is an individual and the merchant is an individual.

18. A method, as in claim 1, wherein payment to the customer's account is made by a third party.

19. A method, as in claim 1, including the additional steps of:
storing the customers account balances on a smart card;
providing means to read a smart card at a merchant facility; and
means to debit the customers account balance for purchases made with the smart card.

20. A method, as in claim 1, including the additional steps of:
storing the customers account balances on a swipe card;
providing means to read a swipe card at a merchant facility; and
means to debit the customers account balance for purchases made with the swipe card.
